(19) United States
(12) Patent Application Publication
(10) Pub. No.: US 2006/0205870 A1
(43) Pub. Date: Sep. 14, 2006

(54) Multifunctional polymer particles and methods of making the same

(75) Inventors: Xiaoru Wang, Webster, NY (US); Wanda K. Swartz, Albion, NY (US); Lawrence P. DeMejo, Rochester, NY (US); Gregory E. Missell, Penfield, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/078,229

(22) Filed: Mar. 11, 2005

(51) Int. Cl. C08F 20/22

(52) U.S. Cl. 524/713

(57) ABSTRACT

The present invention relates to a coating or composition comprising, and a method of making, multifunctional polymer particles comprising at least two reactive functionalities in the same particle, for example, an epoxy-functional or hydroxy-functional group in combination with an acid-functional group. Non-porous or porous coating compositions made from such a dispersion can be used to protect various substrates, including imaging layers, so that the coated product resists fingerprints, common stains, and spills.

### CROSS-REFERENCE TO RELATED APPLICATIONS

The present application is related to U.S. application Ser. No. ______ (docket 89252) by WANG et al. and entitled, “FUSIBLE REACTIVE MEDIA,” U.S. application Ser. No. ______ (docket 89255 by Missell et al. and entitled, “FUSIBLE REACTIVE MEDIA COMPRISING CROSSLINKER-CONTAINING LAYER,” and U.S. application Ser. No. ______ (docket 89323) by Missell et al. and entitled, “INKJET MEDIA COMPRISING MIXTURE OF FUSIBLE REACTIVE POLYMER PARTICLES,” all filed concurrently herewith.

### FIELD OF THE INVENTION

The present invention relates to methods of making, and compositions comprising, multifunctional polymer particles that comprise at least two complementary crosslinking functionalities in the same particle, including the same polymer molecule. Aqueous dispersions and coating compositions made from such dispersions can be applied to various substrates or supports.

### BACKGROUND OF THE INVENTION

Aqueous dispersions of epoxy-containing particles have been prepared by various methods known in the art. One such method of preparing aqueous dispersions is the so-called “inverse emulsification” technique such as disclosed in U.S. Pat. No. 5,741,835 to Stark. The process typically involves melting an epoxy compound and a surfactant together. Optionally a base is added to the melt. Hot water is then slowly added to the epoxy melt at vigorous agitation until inversion takes place, from a water-in-oil to an oil-in-water mixture, after which additional water can be added. Stark states that the invention provides a stable good aqueous dispersion having an average particle size of preferably less than about 2 μm, more preferably less than about 1 μm.

U.S. Pat. No. 4,446,258 to Chu et al. discloses dispersing the reaction product of an epoxy resin and an acid polymer. Preferably, the ionic epoxy-resin-acid polymer product is dispersed in water with ammonia or an amine, to neutralize the polymer product, in the presence of a polymeric surfactant.

Such water-borne products of carboxy-functional polymers and epoxy-functional polymers have been widely used in coatings for decorative and/or protective purposes, for example, in the fields of architectural, automotive, and industrial coatings. Such coatings have general utility for coating metallic and various other substrates and articles, including, for example, metallic cans. As mentioned in U.S. Pat. No. 4,247,439 to Matthews et al., such coatings can provide, for example, corrosion resistance, gloss, hydrolytic stability, non-adulterating of foods and beverages in contact therewith.

In the field of imaging, there have been attempts over the years to provide a protective coating for gelatin-based photographic products that will protect the images from damage by water or aqueous solutions. A number of patents describe methods of solvent coating a protective layer on the image after photographic processing is completed, for example, U.S. Pat. Nos. 2,259,009; 2,331,746; 2,798,004; 3,113,867; 3,190,197; 3,415,670; 3,733,293; 5,853,926; and 5,856,051. The polymers exemplified in U.S. Pat. No. 5,856,051 include polyethylenes having a melting temperature (Tm) of 55 to 200° C. A layer comprising such polymers is capable of becoming water-resistant by fusing the layer at a temperature higher than the Tm of the polymer, after the sample has been processed to generate the image.

Crosslinked overcoats for imaging elements are also known in the art. For example, U.S. Pat. No. 6,436,617 relates to protective overcoats, for photographic image elements, comprising water-dispersible latex particles, which particles comprise an epoxy material and a thermoplastic acid polymer, a water-soluble hydrophilic polymer, and a hydrophobically modified associative thickener. The hydrophilic polymer is substantially washed out during photographic processing facilitating the coalescence of the other materials. Another driving force for this coalescence is the elevated temperature during the drying associated with photoprocessing.

U.S. Pat. No. 6,548,182 relates to an inkjet recording material wherein a coating comprises a water-soluble polymer having a plurality of carboxyl groups in combination with a water-soluble oxazoline compound as a crosslinking agent. EP 0 320 594 A2 discloses aqueous crosslinkable resin dispersions for use in fusible inkjet media, however, in which polymeric particles react with an emulsifier compound.

Commonly assigned U.S. Ser. No. 10/881,127 discloses an inkjet recording element comprising a support having thereon in order from the top:

(a) a fusible, porous pigment-trapping layer comprising (i) fusible polymer particles comprising a thermoplastic polymer with reactive functional groups, (ii) a multifunctional compound having complementary reactive functional groups capable of crosslinking the reactive functional groups on the thermoplastic polymer, and (iii) an optional binder; and

(b) an optional ink-carrier-liquid receptive layer.

The support may also function as a liquid-absorbing sump layer either alone or in combination with the optional ink-carrier-liquid receptive layer.

Similarly, commonly assigned U.S. Ser. No. 10/881,264 discloses an inkjet recording element comprising a support having thereon, in order from the top:

(a) a fusible, porous ink-transporting layer comprising (i) fusible polymer particles comprising a thermoplastic polymer with reactive functional groups, (ii) a multifunctional compound having complementary reactive functional groups capable of crosslinking the reactive functional groups on the thermoplastic polymer, and (iii) an optional binder;

(b) a fusible dye-trapping layer comprising fusible polymer particles, a dye mordant, and an optional hydrophilic binder; and

(c) an optional an ink-carrier-liquid receptive layer.

An objective of the present invention is to provide an improved method of making an aqueous dispersion involving reactive particles for use in a coating composition that can be used to cover and protect various substrates. It is desirable that one such use be to protect imaged elements such as inkjet or other prints, so that the coated product resists fingerprints, common stains, and spills. The coating composition of the present invention can be used to provide an improved inkjet recording element comprising an upper porous layer that can be fused after printing to render images resistant to water and stain.

### SUMMARY OF THE INVENTION

The present invention relates to compositions, including aqueous dispersions, comprising multifunctional particles that comprise diverse reactive groups, for example, an epoxy-functional and acid-functional polymer particle for use in coating compositions. Such coatings can be used to protect various substrates including inkjet prints.

The invention is also directed to a method of making such multifunctional particles.

Another aspect of the invention provides a coating formed by applying a composition according to the present invention to a substrate. During or after drying the coated composition, the coating can be crosslinked by subjected the coating to heating or fusing, thereby producing a clear or colored coating that can be used to protect the substrate from environmental damage.

### DETAILED DESCRIPTION OF THE INVENTION

The present invention provides a simple and inexpensive way to make an aqueous dispersion of multifunctional polymer particles each comprising reactive crosslinking functionalities. In accordance with the invention, a coating composition comprising such multifunctional particles can be applied over a substrate. For example, an overcoat formulation according to the present invention can be applied as the topcoat of an inkjet recording element, particularly for photographic quality prints that may encounter frequent handling and abuse by end users.

In a preferred embodiment of the invention, the multifunctional polymer particles are substantially spherical and monodisperse. Monodisperse particles may be advantageous for controlling fluid absorption and can be used to improve dry time. On the other hand, monodispersed particles may be more difficult to make.

The UPA monodispersity (“Dp”) is defined as the weight average molecular weight divided by the number average molecular weight of the polymers in the bead, as measured by a Microtrac® Ultra Fine Particle Analyzer (Leeds and Northrup) at a 50% median value. This is another way of saying that the particle size distribution is relatively narrow which, in combination with the particle (or “bead”) size, is important for the desired capillary action.

The multifunctional polymer particles may have a particle size conducive to forming a porous layer in some cases. In a particularly preferred embodiment of the invention, the average particle size of the polymer particles suitably ranges from about 5 to about 10,000 nm, and the monodispersity of the particles (Dp) is less than 1.5, preferably less than 1.3, more preferably less than 1.1. Preferably, the polymer particles in the present dispersion range in size from about 50 to 5,000 nm, more preferably 0.1 to about 2 μm, most preferably 0.2 to 1 μm.

In a preferred embodiment of the invention, the multifunctional polymer particles comprise a chain growth polymer, for example, a styrenic polymer, a vinyl polymer, an ethylene-vinyl chloride copolymer, a polyacrylate, poly(vinyl acetate), poly(vinylidene chloride), and/or a vinyl acetate-vinyl chloride copolymer. In a specifically preferred embodiment of the invention, the multifunctional polymer particles are comprised of a polyacrylate polymer or copolymer (for example, acrylic beads) comprising one or more monomeric units derived from an alkyl acrylate or alkyl methacrylate monomer, wherein the alkyl group preferably has 1 to 6 carbon atoms.

As indicated above, the multifunctional polymer particles comprise a polymer having diverse reactive functional groups that are complementary to each other. The number average molecular weight of the polymer can range from 5,000 to 1,000,000, and the glass transition temperature thereof preferably ranges from −50° C. to 120° C. Preferably, the Tg of the multifunctional polymer particles is above about 20° C. and less than 120° C., more preferably above 50° C. and below 90° C. and most preferably below 80° C. The multifunctional polymer may be linear or branched, and the functional groups may be on the same chain or, for example in the case of a branched polymer, on different chain segments of the same molecule.

The multifunctional polymer particles may be the reaction products of a mixture of (different types of) monomers comprising one or more non-reactive monomers and two or more reactive functional monomers, each of which reactive functional monomers comprise a crosslinking-functional group that can react with a complementary crosslinking-functional group on another reactive functional monomer in a crosslinking reaction. Thus, first reactive functionalities on a first reactive functional monomeric unit in each of the multifunctional polymer particles can complementarily react with second reactive functionalities on a second reactive functional monomeric unit in the same molecule or on other molecules in the same particle or one or more other particles, in an intra-molecular crosslinking reaction and/or an inter-molecular crosslinking reaction. Such reactive functional monomers may include monomers containing one or more of the following groups: cyanate, oxazoline, epoxy, acid, anhydrides, hydroxyl, phenol, acetoacetoxy, thiol and/or amine functionalities, and the like.

A dispersion according to the present invention may comprise a mixture of different particles or may comprise only the same particles. For example, the dispersion may comprise mixtures of (different) multifunctional polymer particles, or mixtures of multifunctional polymer particles with monofunctional or non-functional particles. Nevertheless, the multifunctional polymer particles are present in at least a substantial amount by weight in the dispersion. Preferably most, more preferably substantially all, most preferably all, by weight, of the particles in the dispersion are multifunctional polymer particles, each having complementary reaction functionality within the same polymer particle.

Preferably the multifunctional polymer particles may comprise 0.1 to 50 mole percent of reactive monomeric units, more preferably 1 to 50 mole percent, most preferably less than 30 mole percent. Too much crosslinking can result in undesirable brittleness. The multifunctional polymer particles may comprise 50 to 99.9 mole percent of non-reactive monomeric units.

Optionally, there can be added polyfunctional crosslinking compounds that comprise 0.1 to 100 mole percent of complementary reactive monomeric units, more preferably 1 to 50 mole percent, wherein the multifunctional particles can react with either other particles or the polyfunctional crosslinking compounds. The polyfunctional crosslinking compounds may comprise 0 to 99.9 mole percent of non-reactive monomeric units, the same (monofunctional) or different (polyfunctional). Such non-particulate polyfunctional crosslinking compounds are disclosed in copending U.S. Ser. No. 10/881,264 and U.S. Ser. No. 10/881,127, both herein incorporated by reference in its entirety.

In a preferred embodiment, the multifunctional polymer particles can be characterized by a “functional group equivalent weight” (also referred to as the monomer equivalent weight) which is defined as the grams of solid containing one gram-equivalent of a functional group (“g/equivalent”)). (It is possible for a monomer to have more than one functional group, for example, two acid groups, on the same monomer.) The g/equivalent ratio of a first functional group on the multifunctional polymer particles in the dispersion, more specifically on the thermoplastic polymer, to the second or complementary reactive functional groups on the particles (in total) in the inkjet recording element of the invention ranges, on average, from 1.0/0.1 to 0.1/1.0 and more preferably, on average, from 1.0/0.5 to 0.5/1.0. This may vary, for example, in the case of additional functional groups on other types of particles or compounds in reactive association with the multifunctional polymer particles.

As indicated above, the multifunctional polymer particles comprise complementary reactive functional groups. For example, a multifunctional polymer particle can comprise epoxy-functional monomeric units in combination with one or more other functional monomeric units which will react with the epoxy functional group, such as monomeric units comprising an amine, a carboxylic acid, hydroxyl, thiol, anhydride or the like reactive functionalities in the polymer particle. Similarly, an oxazoline group will complementarily react with various protic-functional monomers.

Preferred examples of oxazoline-functional monomeric units are derived from monomers such as 2-vinyl-2-oxazoline and 2-isopropenyl-2-oxazoline. Examples of functional monomeric units with protic-type reactive functionalities include those derived from acid-functional monomers such as methacrylic acid or hydroxy-functional monomers such as hydroxyalkyl (meth)acrylates, for example, hydroxyethyl (meth)acrylate. As described further below, the acid monomer can be an ethylenically unsaturated acid, monoprotic or diprotic, anhydride, acid chloride or monoester of a dibasic acid, which is copolymerizable with the other monomer(s) used to prepare the polymer. The most preferred ethylenically unsaturated acid monomers are acrylic acid, methacrylic acid, and itaconic acid.

In general, epoxy-functional reactive groups in the multifunctional polymer particle can react with carboxylic acid (—COOH), anhydride, hydroxyl (—OH), primary amine (—NH₂ ) groups or thiol groups (—SH) in the polymer particles, for example, multifunctional polymer particles can comprise monomeric units derived from an epoxy-functional monomer and one or more of the following monomers: methacrylic acid (MAA), hydroxyalkylmethacrylates such as hydroxyethylmethacrylate (HEMA), or aminoalkyl methacrylates such as aminopropylmethacrylate, all common and commercially available monomers. A catalyst may be used to speed the reaction of complementary functional groups during heating or fusing at elevated temperature, as will be understood by the skilled chemist. For example, in the case of alcohols, a catalyst such as 4-dimethylaminopyridine may be used to speed the reaction.

In another embodiment, oxazoline functional groups in the multifunctional polymer particle can be used to similarly react with another functional group in the same polymer particle such as a carboxylic acid, acid anhydride, amine, phenol, hydroxyl and thiol. In one embodiment of the invention, a multifunctional polymer particle can contain repeat units having at least one ring-opening group, an epoxide or an oxazoline group, that can react with other non-ring-opening functional groups in the same polymer particle, for example, having a protic group, such as a carboxylic acid containing monomer. Included among useful protic reactive monomers are acrylic, methacrylic, itaconic, crotonic, fumaric and maleic acids, and anhydrides thereof.

Suitable copolymerizable monomers for making the polymeric multifunctional particles include conventional vinyl monomers such as acrylates and methacrylates of the general formula: 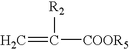
where R₂ is a hydrogen or alkyl, preferably methyl, and R₅ is methyl or a straight chain or branched aliphatic, cycloaliphatic or aromatic group having up to 20 carbon atoms that is unsubstituted or substituted.

Useful or suitable copolymerizable monomers include, for example: methyl-, ethyl-, propyl-, isopropyl-, butyl-, ethoxyethyl-, methoxyethyl-, ethoxypropyl-, phenyl-, benzyl-, cyclohexyl-, hexafluoroisopropyl-, or n-octyl-acrylates and -methacrylates, as well as, for example, styrene, alpha-methylstyrene, 1-hexene, vinyl chloride, etc.

In one preferred embodiment of the present invention, the multifunctional polymer particle comprises an oxazoline group represented by the following formula: 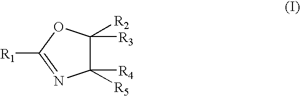
wherein R₁ through R₅ are selected so to provide a branched or unbranched vinyl oxazoline compound, for example, by selecting R₁ in (I) to be a branched or unbranched vinyl group according to formula (II): 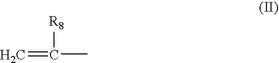
wherein R₈ is selected from the group consisting of hydrogen, a branched or linear C₁-C₂₀ alkyl moiety, a C₃-C₂₀ cycloalkyl moiety, a C₆-C₂₀ aryl moiety, and a C₇-C₂₀ alkylaryl moiety. If R₁ is such a vinyl group, R₂ to R₅ are the same or different and are selected from hydrogen, a branched or linear C₁-C₂₀ alkyl moiety, a C₃-C₂₀ cycloalkyl moiety, a C₆-C₂₀ aryl moiety and a C₇-C₂₀ alkyaryl moiety.

An oxazoline-functional monomeric unit, derived from the monomer, will provide a polymer with a moiety that is reactive to other complementary reactive functionalities on the same multifunctional polymer particle, such as —COOH, —NH, —SH and —OH (or vice versa). A detailed discussion on the preparation of oxazoline compounds can be found in Brenton et al., “Preparation of Functionalized Oxazolines,” Synthetic Communications, 22(17), 2543-2554 (1992); Wiley et al., “The Chemistry of Oxazolines,” Chemical Reviews, v 44, 447-476 (1949); and Frump, John A., “Oxazolines, Their Preparation, Reactions, and Applications,” Chemical Reviews, v 71, 483-505 (1971), the disclosures of which are incorporated by reference.

Examples of a multifunctional polymer particle having an oxazoline group include polymers containing an oxazoline group as obtained by copolymerizing an addition-polymerizable oxazoline monomer with monomers copolymerizable therewith. Examples of the addition-polymerizable oxazoline monomers include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, 2-isopropenyl-4-ethyl-2-oxazoline, 2-isopropenyl-5-methyl-2-oxazoline, 2-isopropenyl-5-ethyl-2-oxazoline, and 2-isopropenyl-4,5-dimethyl-2-oxazoline. These may be used alone, respectively, or in combinations with each other. The monomer 2-isopropenyl-2oxazoline, for example, a non-limiting example of a vinyl oxazoline, is represented by the following structure:

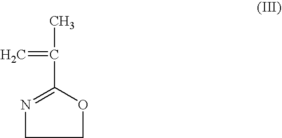

Reactive monomers that are copolymerizable with such addition-polymerizable oxazoline monomer include, by way of example, other oxazoline containing monomers, e.g., 2-vinyl-2-oxazoline, 2-vinyl-4-methyl-2-oxazoline, 2-vinyl-5-methyl-2-oxazoline, 2-isopropenyl-4-methyl-2-oxazoline, and 2-isopropenyl-5-ethyl-2-oxazoline, acrylates or methacrylates, e.g., methyl acrylate, methyl methacrylate, ethyl acrylate, ethyl methacrylate, butyl acrylate, butyl methacrylate, 2-ethylhexyl acrylate, and 2-ethylhexyl methacrylate; unsaturated carboxylic acids, e.g., acrylic acid, methacrylic acid, itaconic acid, and maleic acid; unsaturated nitriles, e.g., acrylonitrile and methacrylonitrile; unsaturated amides, e.g., acrylamide, methacrylamide, N-methylolacrylamide, and N-methylolmethacrylamide; vinyl esters, e.g., vinyl acetate and vinyl propionate; vinyl ethers, e.g., methyl vinyl ether and ethyl vinyl ether; olefins, e.g., ethylene and propylene; halogen-containing alpha-, beta-unsaturated monomers, e.g., vinyl chloride, vinylidene chloride, and vinyl fluoride; and alpha-, beta-unsaturated aromatic monomers, e.g., styrene and alpha-methylstyrene.

In another embodiment of the invention, a ring-opening reactive group in a multifunctional polymer particle is provided by an epoxy-functionality polymer. The preferred epoxy-containing multifunctional polymer particle is based on an oxirane-containing monomer such as epichlorohydrin, glycidyl methacrylate, allyl glycidyl ether, 4-vinyl-1-cyclohexene-1,2-epoxide, and the like, although other epoxy-containing monomers may be used.

Another aspect of the present invention is directed to a method of making the above-described multifunctional polymer particles, which are synthesized from the corresponding monomers to form a colloidal dispersion of particles. In one embodiment of the method, an aqueous dispersion of multifunctional polymer particles is made which particles comprise a thermoplastic polymer having at least two different reactive functional groups that are capable of reacting with each other to crosslink the thermoplastic polymer when subjected to elevated temperature. The method comprises reacting at least two different monomers with, respectively, the two different reactive-functional groups in an aqueous solvent in the presence of a redox polymerization initiator system comprising first and second redox initiator components, an oxidizing agent and a reducing agent, wherein the temperature of reaction is maintained under about 50° C., preferably under 40° C., such that the reactive functional groups remain substantially unreacted, thereby forming a polymerization product of the monomers in the form of an aqueous dispersion of the multifunctional polymer particles having an average particle size less than 10 μm.

Redox initiator components are compounds capable, in combination, of generating ion radicals. The polymerization initiator system typically comprises a radical generator as an oxidizing agent is combined with a reducing agent. Hydrogen peroxide is an example of such a radical generator, where other possible examples include persulfates such as ammonium persulfate and potassium persulfate; hydroperoxides such as t-butylhydroperoxide and cumene hydroperoxide; secondary cerium salts, permanganates, chlorites; and hypochlorite salts. Such radical generators are preferably used in an amount of 0.01 to 10 wt %, and more preferably 0.1 to 2 wt %, of the polymerizable monomer.

As for reducing agent suitable compounds include L-ascorbic acid or an alkaline metal salt thereof, sulfites such as sodium sulfite and sodium hydrogen sulfite; sodium thiosulfite; cobalt acetate; copper sulfate and ferrous sulfate. Such reducing agents are preferably used in an amount of 0.01 to 10 wt %, and more preferably 0.1 to 2 wt %, of the polymerizable monomer. Persulfate oxidizing agents and metasulfite reducing agents are preferred.

Preferred redox polymerization initiator systems include water-soluble initiators capable of generating ion radicals such as potassium or ammonium persulfate; potassium, sodium or ammonium persulfate, peroxides; sodium metabisulfite, and the like. Preferably, water-soluble potassium, sodium, or ammonium persulfate is employed.

The polymerization reaction is conducted at a temperature of not more than 50° C., preferably under 40° C. In one embodiment, a preferred method of making multifunctional particles for use in a coating or other compositions, according to the present invention, comprises (1) forming an aqueous monomer emulsion comprising at least two different monomers with different reactive-functional groups, a first redox initiator composition (for example, an oxidizing agent) and a surfactant, (2) forming an aqueous mixture comprising a second redox initiator (for example a reducing agent or a reducing agent and an oxidizing agent), and (3) adding the aqueous monomer emulsion to the aqueous mixture over an extended period of time to form a polymerization product of the monomers. Preferably, the aqueous mixture comprises deionized water. The dispersion product can be filtered and dispersed in a second aqueous solvent if desired.

Such a process advantageously provides very fine submicron or micron size multifunctional particles having a narrow particle size distribution. The average particle size is less than 10 μm. This contributes to improved coating properties. The dispersions also have excellent stability during storage.

The concentration of the multifunctional polymeric particles in an aqueous dispersion product, for use in coating, is preferably 10 to 60%, more preferably 20 to 40% by weight of solids.

Suitably, in steps (1), (2) and (3), the temperature is essentially maintained at a temperature less than about 50° C., preferably less than 40° C., such that the reactive functionalities remain substantially unreacted. Particularly, in step (3), the temperature of polymerization is maintained at a temperature less than about 50° C., preferably less than 40° C., such that the reactive functionalities remain substantially unreacted. Advantageously, in some cases, the process may be conducted at about room temperature. In any case, the temperature should be such that the reactive functionalities are substantially maintained (unreacted), as can be determined by differential scanning calorimetry (DSC), comparing the DSC of particles to fully reacted particles (subject to a temperature greater than 100° C.).

The redox polymerization initiator system can be provided in various ways. For example, the aqueous mixture in addition to the monomer emulsion can comprise an oxidizing agent, preferably, in an amount, on a molar basis, less that the reducing agent.

Alternatively, an aqueous monomer emulsion can be formed comprising, in admixture in a single reactor, (a) the total amount of monomer to be reacted, including the least two different monomers with, respectively, different reactive-functional groups, (b) the total amount of the redox polymerization initiator system, and (c) optionally a surfactant, wherein the temperature of reaction is maintained under about 50° C., thereby allowing the use of the single reactor without the addition of monomer over an extended period of time. For example, the mixture can be mixed at 20° C. and then the temperature elevated to a temperature from 30 to 50° C. to react. Thus, both redox initiator components may be present in an aqueous monomer emulsion if maintained at a sufficiently low temperature, thereby allowing a single pot reactor. However, a two-pot arrangement can provide better control of the reaction.

In the present method, the monomers can form an emulsion, suspension, or soluble mixture in the aqueous solvent. Preferably, a monomer emulsion or suspension is employed in which the initiator components are soluble in the monomers.

Preferably, the aqueous solvent in the dispersion of polymer particles made by the process, or formed therefrom for use in a coating composition, comprises at least 60 percent, more preferably at least 80 percent, by volume, of water. The aqueous solvents, however, can comprise zero or up to 20 percent by volume of a water miscible organic solvent, wherein water miscible means the solubility in water is at least 10 percent, preferably at least 20 percent. Suitable miscible organic solvents include, for example: acetone, methyl ethyl ketone, ethyl alcohol, methyl, alcohol, isopropyl alcohol, n-propyl alcohol, tetrahydrofuran, ethylene glycol monomethyl ether, N-methylpyrrolidone, dimethylformamide, dimethyl sulfoxide, butyldiethoxy alcohol, and dipropylene glycol methyl ether. However, it is preferred to use 100% water in the aqueous solvent.

Optionally, various dispersants and surfactants known in the art can be used as stabilizers in forming the aqueous dispersion. The dispersants can be nonionic, anionic, and cationic, and can be polymeric and are used as high as 20% by weight of the polymer particles. Because such surfactants are a potential cause of other problems, a minimum amount of surfactant should be used. If the dispersion of polymer particles coagulates or coalesces, then addition of measured amounts of surfactant to freshly prepared dispersions or to the aqueous phase used to prepare the dispersion can be used to assess the stability of the dispersion. Most preferably, the dispersion will be stable with regards to sedimentation of the dispersed phase. However, in the context of the subject invention, the term “stable” refers to a dispersion where the multifunctional polymer particles do not coalesce or coagulate, but remain substantially as distinct particles. If such particles sediment upon storage, they may be easily redispersed by shaking or moderate agitation. If, however, the particles coalesce, they cannot be redispersed without high shear mixing for prolonged periods of time.

The solvent for the final dispersion, as sold or applied, comprises primarily water, suitably at least 50 percent, preferably 60 to 80 percent by weight water.

Another aspect of the invention is directed to a method of making a coating composition comprising the above-described dispersion and optionally combining the dispersion with a polymeric binder. The coating composition may consist of the dispersion alone or combined with other ingredients. Optionally, the dispersed multifunctional polymer particles are combined or mixed with a polymeric binder. Suitable polymeric binders include, but are not limited to, water soluble polymers or colloidal polymeric particles prepared by emulsion polymerization or by emulsifying pre-formed polymers in water using a proper dispersing method or using a proper dispersing agent.

Suitably, the multifunctional polymer particles are present in the coating composition in an amount of at least 10% by dry weight. (Preferably, the weight ratio of the water-dispersible multifunctional particles to the polymeric binder is between 90:10 to 10:90, more preferably, at least in some embodiments, 50:50 and 80:20, depending on whether the binder is water-soluble or a water-dispersible hydrophobic particle or latex.)

The multifunctional polymer particles can be used to form a porous or non-porous coating. For a porous coating, lower binder levels, i.e. less than or equal to 10%, are preferable for two reasons, higher porosity in the final coated structure and lower viscosity of the coating melt to render it more suitable for higher speed (lower cost) coating processes, such as rod coating. The range of binder levels from 0 to 50% by weight would encompass porous inkjet coatings at the low end and non-porous protective coatings at the high end.

Compositions according to the present invention can also be used to form a durable, environmentally resistant coating. The composition can be used for maintenance coatings for architectural structures and for finishing the exterior of automobiles and trucks. The composition can be pigmented to form a colored finish or unpigmented for use as a clearcoat. The composition can be applied as a topcoat to a substrate by conventional techniques such as spraying. The resulting coating can be dried and cured at elevated temperature of greater than 100° C., preferably 100 to 150° C. Coatings can be applied to architectural surfaces and appliances to from a finish typically about 0.05 to 5 mils thick.

To improve the weatherability of the coating made from the coating composition, about 0.1 to 5% by weight, based on the weight of solids, of an ultraviolet light stabilizer or combinations thereof, can be added, either within the polymeric particles or to the dispersion of the polymer particles. These stabilizers include ultraviolet light absorbers, screeners, quenchers and specific hindered amine light stabilizers. Also, about 0.1 to 5% by weight, based on the solids weight, of an antioxidant can be used. Typical ultraviolet light stabilizers that are useful are listed, for example, in U.S. Pat. No. 4,906,677.

Optional components or additives that can be located in the multifunctional polymer particles, in addition to the thermoplastic polymer described above, can include stabilizers and antioxidants.

Another aspect of the invention is directed to a method of coating a substrate comprising coating a substrate with a coating composition comprising the afore-described dispersion and heating the applied coating to promote reaction of the reactive functionalities. Suitable, the coating is less than 125 microns thick, preferably less than 25 microns.

The aqueous dispersions can be used to make coating compositions, wherein the coating composition can be used to coat various substrates, either to provide a transparent protective layer or to provide a colored layer comprising a pigment. Substrates may include, for example, a floor, wall, appliance, automobile, or part thereof. In one embodiment, the substrate is an imaging element. Therefore, another aspect of the present invention relates to a method of making an imaging element having a protective overcoat, wherein the protective overcoat is made from a coating composition comprising multifunctional particles, said particles having been formed by the above described method. Non-porous or porous coatings can be used. Applications of porous coatings include, for example, imaging elements, inkjet media, and medical applications. A porous material can be used to absorb and store biological samples for testing.

In the case of non-porous protective coatings, it has long been known that rheological additives, which are added at only a relatively small weight percentage to aqueous coating systems, can modify the coating rheology to satisfy various coating application requirements. Aqueous systems so modified have included latex paints, protective coatings, paper coatings, household detergents, cosmetics and personal care items, adhesives and sealants, inks, drilling fluids, and the like. Rheological additives are thixotropes which impart a three dimensional network to liquid systems as expressed by increased viscosity at low shear rates. When the system is sheared at high shear rates, this network is broken down, resulting in a decrease in viscosity; the network recovers when the external force is removed. Rheological additives are added at about 0.01% to about 10% (depending on the thickener, the characteristics of the system to be thickened and the desired rheological profile) based on the total weight of the system to be thickened. Often the terms thixotrope, thickener, and rheological additive are used interchangeably. Many rheological additives for aqueous based systems are available: natural, modified natural and synthetic. Natural rheological additives include guar gum, pectin, casein, carrageen, xanthan gum and alginates. Modified additives include modified celluloses, most particularly methylcellulose, hydroxyethyl cellulose, hydroxypropyl cellulose, and carboxymethyl cellulose.

Alternatively, the multifunctional particles can also be coated, as a powder composition, by a spraying technique. For example, conventional electrostatic spraying can be employed to coat the multifunctional particles.

Examples of surfactants as coating aids include any surface-active material that will lower the surface tension of the coating preparation sufficiently to prevent edge-withdrawal, repellencies, and other coating defects. These include alkyloxy- or alkylphenoxypolyether or polyglycidol derivatives and their sulfates, such as nonylphenoxypoly(glycidol) available from Olin Matheson Corporation or sodium octylphenoxypoly(ethylene oxide) sulfate, organic sulfates or sulfonates, such as sodium dodecyl sulfate, sodium dodecyl sulfonate, sodium bis(2-ethylhexyl)sulfosuccinate (AEROSOL OT), and alkylcarboxylate salts such as sodium decanoate, silicone surfactants and fluorosurfactants.

The surface characteristics of the overcoat are in large part dependent upon the physical characteristics of the multifunctional polymer particles. However, the surface characteristics of the overcoat also can be modified by the conditions under which the surface is optionally fused. For example, in contact fusing, the surface characteristics of the fusing element that is used to fuse the polymers, to form the continuous overcoat layer, can be selected to impart a desired degree of smoothness, texture or pattern to the surface of the element. Thus, a highly smooth fusing element will give a glossy surface to the imaged element, a textured fusing element will give a matte or otherwise textured surface to the element, a patterned fusing element will apply a pattern to the surface of the element, etc.

The coating composition made according to the invention can be applied by any of a number of well known techniques, such as dip coating, rod coating, blade coating, air knife coating, gravure coating and reverse roll coating, extrusion coating, slide coating, curtain coating, and the like. After coating, the layer is generally dried by simple evaporation, which may be accelerated by known techniques such as convection heating. The laydown of the overcoat will depend on its field of application.

In one particular embodiment, the present invention provides a method of making an improved overcoat formulation for the imaging side of an imaging element or material, including inkjet prints, which encounter frequent handling and abuse by end users. An inkjet recording element typically comprises a support having on at least one surface thereof at least one ink-receiving layer. The ink-receiving layer is typically either a porous layer that imbibes the ink via capillary action or a polymer layer that swells to absorb the ink. Transparent swellable hydrophilic polymer layers do not scatter light and therefore afford optimal image density and gamut, but may take an undesirably long time to dry. Porous ink-receiving layers are usually composed of inorganic or organic particles bonded together by a binder. During the inkjet printing process, ink droplets are rapidly absorbed into the coating through capillary action, and the image is dry-to-touch right after it comes out of the printer. Therefore, porous coatings allow a fast “drying” of the ink and produce a smear-resistant image. However porous layers, by virtue of the large number of air-particle interfaces, scatter light that may result in lower densities of printed images.

Inkjet prints prepared by printing onto inkjet recording elements are subject to environmental degradation. They are especially vulnerable to damage resulting from contact with water and atmospheric gases, such as ozone. Ozone can bleach inkjet dyes resulting in loss of density. Porous layers are particularly vulnerable to atmospheric gases in view of the open pores. The damage resulting from the post-imaging contact with water can take the form of water spots resulting from deglossing of the top coat, dye smearing due to unwanted dye diffusion, and even gross dissolution of the image recording layer. To overcome these deficiencies, an overcoat formulation according to the present invention can be used to form an upper layer. Fusing the upper layer after printing the image has the advantage of both providing a protective overcoat for water and stain resistance and reducing light scatter for improved image quality.

An example of one embodiment of an inkjet recording element that can be made using the dispersion of the present invention comprises a support having thereon in order:

a) an upper fusible, porous layer comprising (i) fusible multifunctional polymer particles each such particle comprising a thermoplastic polymer with at least two different reactive functional groups that can crosslink with each other in the same polymer chain, particle and/or with such reactive functional groups in another such particle, and (ii) an optional binder; and

b) an optional lower porous layer that is fusible or non-fusible and that is receptive to ink-carrier liquid, which may optionally comprise a mordant.

As used herein, the terms “over,” “above,” “upper,’ “under,” “below,” “lower,” and the like, with respect to layers in the inkjet media, refer to the order of the layers over the support, but do not necessarily indicate that the layers are immediately adjacent or that there are no intermediate layers.

After printing an image on the media, the fusing and concurrent crosslinking should be sufficiently complete. Insufficient fusing or crosslinking can result in a tacky, brittle or discontinuous surface and, if the fusible, porous layer remains porous, is too brittle or cracks, the inkjet element will not be water and stain resistant, as well as not have the desired anti-blocking properties.

The multifunctional polymer particles are intended to flow and crosslink when heated or fused, for example, fusing of an imaging element in a heated fuser nip, thereby achieving inkjet surface coatings and media with excellent image quality and print durability performance.

The particle-to-binder ratio of the particles and optional binder employed in a dispersion for an inkjet overcoat can range between about 100:0 and 60:40, preferably between about 100:0 and about 90:10. In general, for a porous layer, particle-to-binder ratios outside the range stated will usually not be sufficiently porous to provide good image quality.

When used to make an upper fusible, porous ink-trapping layer, the coating comprising the multifunctional particles is usually present in an amount from about 1 g/m² to about 50 g/m². In a preferred embodiment, the fusible, porous layer is present in an amount from about 1 g/m² to about 10 g/m².

Upon fusing, via the application of heat and/or pressure, the air-particle interfaces present in the original porous structure of the layer are eliminated, and a non-scattering, substantially continuous layer forms which contains the printed image. In this application, the fusible, porous layer is transformable into a non-scattering layer, as this significantly raises image density.

The support for an inkjet recording element may optionally function as a liquid-absorbing or sump layer either alone or in combination with the optional lower porous layer. This inkjet recording element includes that intended for use with dye-based inks, pigment-based inks, or both. In the case of printing with dye-based inks, the inkjet recording element may be designed for the lower porous layer to preferably function as a primary dye-trapping layer separate from the upper fusible, porous layer. In the case of printing with pigment-based inks, the inkjet recording element may be designed either without a lower porous layer or for the lower porous layer to preferably function as a sump layer; however, it is also possible for the upper fusible, porous layer to function as either a dye-trapping or a pigment-trapping layer, depending on the ink composition used for printing, with the optional lower porous layer functioning as a sump layer.

In a first embodiment, the upper fusible, porous layer is designed to preferably function as a pigment-trapping upper layer.

In a second embodiment, the upper fusible, porous layer is designed to preferably alternatively function as both a pigment-trapping layer and a dye-trapping layer, i.e., the printed image is formed in the upper fusible, porous layer irrespective of the ink composition.

In yet a third embodiment, the upper fusible, porous layer is designed to preferably function as an ink-receptive layer and, below the upper fusible, porous layer, there is a lower fusible, porous dye-trapping layer comprising fusible polymer particles (not necessarily crosslinkable), an optional dye mordant, and an optional hydrophilic binder. Also, optionally, an ink-carrier-liquid receptive layer is below the lower fusible, porous dye-trapping layer.

In this third embodiment, the dye-trapping layer and/or the support may optionally function as a liquid-absorbing sump layer to some extent, either alone or in combination with the optional ink-carrier-liquid receptive layer.

Also, in this third embodiment, the upper fusible, porous layer may optionally comprise a hydrophobic polymeric binder to promote the transfer of a portion or all of the aqueous ink, including dye to a lower layer comprising more hydrophilic materials. Thus, the colorant in the ink can be distributed between two fusible layers or, alternatively, substantially all of the ink colorant can be transported to the lower fusible, porous dye-trapping layer, in which case the upper fusible, porous layer may be referred to as an ink-transporting layer.

Although the first and third embodiments described above involve recording elements designed preferably for printing with either pigment-based inks or dye-based inks, it is also possible to print on them with either type of inks. For example, the ink-transporting layer in the second embodiment can also function as a pigment-trapping layer, or the pigment-trapping layer can also function as a dye-trapping layer. Also, as in the second embodiment, it is possible to design a “universal” recording element intended for use, irrespective of whether pigment or dye-based inks are employed. In a preferred embodiment of such a universal recording element, there is no separate dye-trapping layer under the upper fusible, porous layer and, accordingly, only one fusible layer.

By the term “porous” layer is meant a layer that absorbs applied ink by means of capillary action rather than dye diffusion. Porosity can be affected by the particle to binder geometry. The porosity of a mixture may be predicted based on the critical pigment volume concentration (CPVC).

The optional porous ink-carrier-liquid receptive layer receives the ink carrier liquid after passing through the upper fusible, porous layer, where substantially all the colorant has been removed. The optional porous ink-carrier-liquid receptive layer receives the ink carrier liquid after the ink has passed through the porous ink-transporting layer and through the porous dye-trapping layer where substantially all the dye has been removed. The ink-carrier-liquid receptive layer can be any conventional porous structure. In a preferred embodiment, the ink-carrier-liquid receptive layer is present in an amount from about 1 g/m² to about 50 g/m², preferably from about 10 g/m² to about 45 g/m². The thickness of this layer may depend on whether a porous or non-porous support is used.

In general, the porous ink-carrier-liquid receptive layer will have a thickness of about 1 μm to about 50 μm, and an upper fusible, porous residing thereon will usually have a thickness of about 2 μm to about 50 μm.

In one embodiment of an inkjet recording element, the ink-carrier-liquid receptive layer is a continuous, co-extensive porous layer that contains organic or inorganic particles. Examples of organic particles which may be used include core/shell particles such as those disclosed in U.S. Pat. No. 6,492,006 to Kapusniak et al., and homogeneous particles such as those disclosed in U.S. Pat. No. 6,475,602 to Kapusniak et al., the disclosures of which are hereby incorporated by reference. Examples of organic particles that may be used in this layer include acrylic resins, styrenic resins, cellulose derivatives, polyvinyl resins, ethylene-allyl copolymers, polyaddition polymers such as polyurethanes and polycondensation polymers such as polyesters.

Examples of inorganic particles that may be used in the ink-carrier-liquid receptive layer include silica, alumina, titanium dioxide, clay, calcium carbonate, calcium metasilicate, talc, barium sulfate, or zinc oxide. In a preferred embodiment of an inkjet recording element that can be made using the present dispersion, the porous ink-carrier liquid receptive layer comprises from about 20% by weight to about 100% by weight of particles and from about 0% to about 80% by weight of a polymeric binder, preferably from about 80% by weight to about 95% by weight of particles and from about 20% by weight to about 5% by weight of a polymeric binder. In a preferred embodiment, the polymeric binder may be a hydrophilic polymer such as poly(vinyl alcohol), poly(vinyl pyrrolidone), gelatin, cellulose ethers, poly(oxazolines), poly(vinylacetamides), partially hydrolyzed poly(vinyl acetate/vinyl alcohol), poly(acrylic acid), poly(acrylamide), poly(alkylene oxide), sulfonated or phosphated polyesters and polystyrenes, casein, zein, albumin, chitin, chitosan, dextran, pectin, collagen derivatives, collodian, agar-agar, arrowroot, guar, carrageenan, tragacanth, xanthan, rhamsan, and the like. Preferably, the hydrophilic polymer is poly(vinyl alcohol), hydroxypropyl cellulose, hydroxypropyl methylcellulose, a poly(alkylene oxide), poly(vinyl pyrrolidinone), poly(vinyl acetate) or copolymers thereof or gelatin.

In order to impart mechanical durability to the ink carrier-liquid receptive layer, crosslinkers that act upon the binder discussed above may be added in small quantities. Such an additive improves the cohesive strength of the layer. Crosslinkers such as carbodiimides, polyfunctional aziridines, aldehydes, isocyanates, epoxides, polyvalent metal cations, vinyl sulfones, pyridinium, pyridylium dication ether, methoxyalkyl melamines, triazines, dioxane derivatives, chrom alum, zirconium sulfate, derivatives of boric acid and the like may be used. Preferably, the crosslinker is an aldehyde, an acetal or a ketal, such as 2,3-dihydroxy-1,4-dioxane.

The porous ink-carrier-liquid receptive layer can also comprise an open-pore polyolefin, open-pore polyester or open-pore membrane. An open-pore membrane can be formed in accordance with the known technique of phase inversion. Examples of a porous ink-receiving layers comprising an open-pore membrane are disclosed in U.S. Pat. No. 6,497,941 and U.S. Pat. No. 6,503,607 both of Landry-Coltrain et al., hereby incorporated by reference.

In one preferred embodiment of an inkjet recording element, the ink carrier-liquid receptive layer is a continuous, co-extensive porous calcium-metasilicate-containing base layer comprising calcium-metasilicate needles, and optionally organic and/or inorganic particles in a polymeric binder. Examples of calcium metasilicate that can be used in the invention include VANSIL acicular Wollastonite. Useful grades, depending on the particular inkjet recording system, include VANSIL WG, VANSIL HR-1500 and HR-325, which are all commercially available from R.T. Vanderbilt Co., Inc., Norwalk, Conn. (website:www.rtvanderbilt.com).

A first embodiment of an inkjet recording element that can be made using a dispersion according to the invention involves an upper (preferably uppermost) fusible, porous layer that is designed to preferably function as a pigment-trapping upper layer, a second embodiment of the invention involves an upper (preferably uppermost) fusible, porous layer that is designed to preferably alternatively function as both a pigment-trapping layer and a dye-trapping layer, i.e., the printed image is formed in the upper fusible, porous layer irrespective of the ink composition, and in yet a third embodiment, the upper fusible, porous layer is designed to preferably function as an ink-transporting layer above a lower fusible, porous dye-trapping layer comprising fusible polymer particles (not necessarily crosslinkable), an optional dye mordant, and an optional hydrophilic binder.

In this third embodiment, the upper fusible, porous layer may, in addition, contain a film-forming hydrophobic binder that may be advantageous in the case of a lower dye-trapping layer that is also fusible. The presence of a minor amount of binder may provide improved raw-stock keeping prior to fusing, durability, and handling capability. The film-forming, hydrophobic binder useful in the invention can be any film-forming hydrophobic polymer capable of being dispersed in water. In a preferred embodiment of the invention, however, there is no binder. If a binder is used, it preferably should be used in a minor amount.

In the case of the upper fusible, porous layer designed to preferably function as an ink-transporting layer in combination with a fusible dye-trapping layer that receives the ink from the upper ink-transporting layer, the fusible dye-trapping layer preferably retains substantially all the dye, and can allow for the passage of the ink carrier liquid to an optional underlying porous ink-carrier-liquid-receptive layer and/or an optionally porous support.

Upon fusing, via the application of heat and/or pressure, the air-particle interfaces present in the original porous structure of the dye-trapping layer (also referred to as the image layer) are eliminated, and a.non-scattering, substantially continuous layer forms that contains the printed image. It is an important feature of this embodiment of the invention that both the fusible, porous ink-transporting layer and the underlying dye-trapping layer be transformable into a non-scattering layer as this significantly raises image density.

The fusible, polymer particles employed in the dye-trapping layer of this embodiment typically range from about 0.1 μm to 10 μm, although smaller particles are possible. The particles employed in the dye-trapping layer may be formed from any polymer that is fusible, i.e., capable of being converted from discrete particles into a substantially continuous layer through the application of heat and/or pressure. In a preferred embodiment, the fusible, polymer particles comprise the ester derivative of a natural polymer, such as cellulose acetate butyrate, a step growth polymer, such as a polyester or a polyurethane, a chain growth polymer, for example, a styrenic polymer, a vinyl polymer, an ethylene-vinyl chloride copolymer, a polyacrylate, poly(vinyl acetate), poly(vinylidene chloride), or a vinyl acetate-vinyl chloride copolymer, and the like.

The binder employed in the dye-trapping layer can be any film-forming polymer that serves to bind together the fusible polymer particles. In a preferred embodiment, the binder is a hydrophobic film-forming binder derived from an aqueous dispersion of an acrylic polymer, a vinyl acetate polymer or polyurethane.

A dye mordant is preferably employed in the dye-trapping layer. Such a dye mordant can be any material that is effectively substantive to the inkjet dyes. The dye mordant removes dyes from the ink received from the porous ink-transporting layer and fixes the dye within the dye-trapping layer. Examples of such mordants include cationic lattices such as disclosed in U.S. Pat. No. 6,297,296 and references cited therein, cationic polymers such as disclosed in U.S. Pat. No. 5,342,688, and multivalent ions as disclosed in U.S. Pat. No. 5,916,673, the disclosures of which are hereby incorporated by reference. Examples of these mordants include polymeric quaternary ammonium compounds, or basic polymers, such as poly(dimethylaminoethyl)-methacrylate, polyalkylenepolyamines, and products of the condensation thereof with dicyanodiamide, amine-epichlorohydrin polycondensates, and polyethyleneimine-epichlorohydrin. Further, lecithins and phospholipid compounds can also be used. Specific examples of such mordants include the following: vinylbenzyl trimethyl ammonium chloride/ethylene glycol dimethacrylate; poly(diallyl dimethyl ammonium chloride); poly(2-N,N,N-trimethylammonium)ethyl methacrylate methosulfate; poly(3-N,N,N-trimethyl-ammonium)propyl methacrylate chloride; a copolymer of vinylpyrrolidinone and vinyl(N-methylimidazolium chloride; and hydroxyethylcellulose derivatized with 3-N,N,N-trimethylammonium)propyl chloride. In a preferred embodiment, the cationic mordant is a quaternary ammonium compound.

In order to be compatible with the mordant, both the binder and the polymer comprising the fusible particles is preferably either uncharged or the same charge as the mordant. Colloidal instability and unwanted aggregation could result if the polymer particles or the binder had a charge opposite from that of the mordant.

In one particular embodiment, the fusible particles in the dye-trapping layer may range from about 95 to about 60 parts by weight, the binder may range from about 40 to about 5 parts by weight, and the dye mordant may range from about 2 parts to about 40 parts by weight. More preferably, the dye-trapping layer comprises about 80 parts by weight fusible particles, about 10 parts by weight binder, and about 10 parts by weight dye mordant. The dye-trapping layer can be present in the recording element in an amount by weight of from about 1 g/m² to about 50 g/m², more preferably in an amount from about 1 g/m² to about 10 g/m².

The support used in the inkjet recording element may be opaque, translucent, or transparent. There may be used, for example, plain papers, resin-coated papers, various plastics including a polyester resin such as poly(ethylene terephthalate), poly(ethylene naphthalate) and poly(ester diacetate), a polycarbonate resin, a polylactic acid, a fluorine resin such as poly(tetra-fluoro ethylene), metal foil, various glass materials, and the like. In a preferred embodiment, the support is an open-structure paper support as used in the examples below. The thickness of the support employed in the invention can be from about 12 to about 500 μm, preferably from about 75 to about 300 μm.

If desired, in order to improve the adhesion of the base layer to the support, the surface of the support may be corona-discharge-treated prior to applying the base layer or solvent-absorbing layer to the support.

Since the inkjet recording element may come in contact with other image recording articles or the drive or transport mechanisms of image recording devices, additives such as surfactants, lubricants, matte particles, and the like may be added to the element to the extent that they do not degrade the properties of interest.

Also, a backside coating may be coated on the opposite side of the support of the inkjet recording element to provide water and stain resistance, front to back thermal blocking resistance, acceptable raw stock keeping, and curl balance. A preferred coating to impart some or all of the characteristics just mentioned is a polymeric coating, such as a polymer latex, containing dispersed hydrophobic polymer particles. Additionally, since this backside coating, like the front side coating, may come in contact with other image recording articles or the drive or transport mechanisms of image recording devices, additives such as surfactants, lubricants, inorganic particles to provide reinforcement, matte spacer particles, and the like may be added to the coating to the extent that they do not degrade the properties of interest.

The layers described above, including the ink-carrier-liquid receptive layer and the upper fusible, porous layer, may be coated by conventional coating means onto a support material commonly used in this art. Depending on the embodiment, a dye-trapping layer and an ink-transporting layer may be similarly coated onto a support material. Coating methods may include, but are not limited to, wound wire rod coating, air-knife coating, slot coating, slide hopper coating, gravure, curtain coating, and the like. Some of these methods allow for simultaneous coatings of all three layers, which is preferred from a manufacturing economic perspective.

After printing on the element of the invention, the upper fusible, porous is heat and/or pressure fused to form a substantially continuous overcoat layer on the surface. Upon fusing, this layer is rendered non-light scattering. The fusing and concurrent crosslinking should be sufficiently complete. Insufficient fusing or crosslinking can result in a tacky surface and, if the fusible, porous layer remains porous, the inkjet element will not be water and stain resistant, as well as not have the desired anti-blocking properties.

Fusing may be accomplished in any manner that is effective for the intended purpose. A description of a fusing method employing a fusing belt can be found in U.S. Pat. No. 5,258,256, and a description of a fusing method employing a fusing roller can be found in U.S. Pat. No. 4,913,991, the disclosures of which are hereby incorporated by reference. If a fusing roller is used, it is advantageously facilitated by the low Tg reactive polymer particles of the present invention.

In a preferred embodiment, fusing is accomplished by contacting the surface of the element with a heat-fusing member, such as a fusing roller or fusing belt. Thus, for example, fusing can be accomplished by passing the element through a pair of heated rollers, heated to a temperature of about 60° C. to about 160° C., using a pressure of 5 to about 15 MPa at a transport rate of about 0.005 m/sec to about 0.5 m/sec.

As mentioned above, lower initial Tg for the fusible polymer particles can be an advantage for fusing at relatively lower temperatures and/or lower pressures, for example less than about 300° F., instead of 350° F. as required for some prior art fusible polymer particles of a cellulose ester. Following fusing and crosslinking, a higher Tg for the top layer of the inkjet element is obtained so that blocking problems are avoided. Also, a further advantage of inkjet media that can be made in accordance with the present invention is that, since less heat may be required to fuse the element, the inkjet element can be released from the fusing element when relatively hot without deformation and without lowering gloss or adversely affecting a smooth surface. This facilitates the use of a fuser roller as compared to a belt fuser that may otherwise be needed to provide longer contact so that the inkjet element has sufficient time to cool before release.

The following examples further illustrate the invention.

### EXAMPLES

Polymer particle dispersions P-1 to P-11 were prepared as follows. Unless otherwise indicated, the particle size was measured by a MICROTRAC Ultra Fine Particle Analyzer (Leeds and Northrup) at a 50% median value.

Synthesis of polymer Particles P-1

The polymer particle dispersions were prepared by an emulsion polymerization technique employing the following components:

| | | |
|---|---|---|
| Part A: | Deionized water | (100 g) |
| | Potassium persulfate | (0.15 g) |
| | Na₂S₂O₅ | (0.9 g) |
| | (Sodium metasulfite) | |
| Part B: | Deionized water | (120 g) |
| | Glycidyl methacrylate | (5.37 g) |
| | Ethyl methacrylate | (17.4 g) |
| | Butyl methacrylate | (39.0 g) |
| | Methylacrylic acid | (3.25 g) |
| | Potassium persulfate | (0.8 g) |
| | SDS | (0.25 g) |
| | 3-Mercaptopropionic acid | (0.75 g) |

Part (A) was first charged to a IL 3-neck flask equipped with a nitrogen inlet, mechanical stirrer and condenser. The flask was immersed in a constant temperature bath at 35° C. and purged with nitrogen for 20 min.

Part (B) was added to the mixture. Agitation was maintained all the time during the feeding of monomer emulsion. The addition time of the monomer emulsion (B) was two hours.

The polymerization was continued for 30 min after the addition of the monomer emulsion.

The mixture was cooled to room temperature and filtered. The final solids were about 22% and the final particle size was about 0.51 μm. The monodispersity was 1.03 as determined by UPA.

Synthesis of polymer particles P-2 to P-11 was performed in the same way as the above sample, except that different compositions or monomers were used.

The average molecular weight of sample P-8 was 46,000 (number-average) and 97,000 (weight-average). Table 1 below shows the detail of the polymer compositions.

TABLE 1

| | | | Average | |
|---|---|---|---|---|
| | | | Particle Size | |
| | Polymer | | (□m) Number | |
| Sample | composition (ratio by weight) | | weighted | Monodispersity |
| P-1 | Glycidyl methacrylate | | 0.5112 | 1.03 |
| | Ethyl methacrylate | | | |
| | Butyl methacrylate | | | |
| | Methacrylic acid | (8/27/60/5) | | |
| P-2 | Glycidyl methacrylate | | 0.2876 | 1.05 |
| | Ethyl methacrylate | | | |
| | Butyl methacrylate | | | |
| | Methacrylic acid | (8/52/35/5) | | |
| P-3 | Glycidyl methacrylate | | 0.4467 | 1.06 |
| | Ethyl methacrylate | | | |
| | Butyl methacrylate | | | |
| | Methacrylic acid | (8/10/77/5) | | |
| P-4 | Ethyl methacrylate | | 0.4 | 1.05 |
| Comp. | Butyl methacrylate | | | |
| | (80/20) | | | |
| P-5 | Ethyl methacrylate | | 0.611 | 1.06 |
| | Butyl methacrylate | | | |
| | Methacrylic acid | (85/10/5) | | |
| P-6 | Glycidyl methacrylate | | 0.5081 | 1.03 |
| | Ethyl methacrylate | | | |
| | Butyl methacrylate | | | |
| | Methacrylic acid | (16/16/58/10) | | |
| P-7 | Glycidyl methacrylate | | 0.5516 | 1.02 |
| | Ethyl methacrylate | | | |
| | Butyl methacrylate | | | |
| | Methacrylic acid | (16/43/31/10) | | |
| P-8 | Ethyl methacrylate | | 0.737 | 1.05 |
| | Butyl methacrylate | | | |
| | Methacrylic acid | (35/60/5) | | |
| P-9 | Hydroxyethyl methacrylate | | 0.334 | 1.02 |
| | Ethyl methacrylate | | | |
| | Butyl methacrylate | | | |
| | Methacrylic acid | (7/26/62/5) | | |
| P-10 | Hydoxyethyl acrylate | | 0.718 | 1.04 |
| | Ethyl methacrylate | | | |
| | Butyl methacrylate | | | |
| | Methacrylic acid | (7/26/62/5) | | |
| P-11 | Hydoxyethyl methacrylate | | 0.95 | 1.1 |
| | Ethyl methacrylate | | | |
| | Butyl methacrylate | | | |
| | Methacrylic acid | (11/20/61/8) | | |

Various inkjet recording elements were prepared comprising the polymeric particles, dispersions thereof, and coating compositions according to the present invention.

### Example 1

A 25% solids aqueous solution was made containing calcium metasilicate (HR325 WOLLASTONITE from R.T. Vanderbilt Company Inc., Norwalk, Conn.), plastic pigment latex (HS3000 NA high-Tg acrylic hollow beads (1 μm), from Dow Chemical, Marietta, Ga.), and polyvinyl alcohol (GH17 GOHSENOL from Nippon Gohsei, Osaka, Japan) at a dry weight ratio of 45/45/10. This was then coated and dried at a dry laydown of 26.9 g/m² (2.5 g/ft²) on DOMTAR QUANTUM 80 paper using a hopper coater to provide an ink-carrier-liquid-receptive layer on a support.

### Example 2

Dispersion P-8 was diluted to make an 18% aqueous dispersion. This was then coated over the ink-carrier-liquid receptive layer of Example 1 at a dry laydown of 8.6 g/m² (0.8 g/sqft) and dried to form a comparative recording element, comprising a fusible porous layer comprising non-reactive thermoplastic polymer particles.

### Example 3

Polymer Particle Dispersion P-1 was used to make an 18% aqueous solution. This was then coated over the ink-carrier-liquid receptive layer of Example 1 at a dry laydown of 8.6 g/m² (0.8g/sq ft) and dried to form a recording element according to the present invention.

### Example 4

Polymer Particle Dispersion P-2 was used to make an 18% aqueous solution. This was then coated over the ink-carrier-liquid receptive layer of Example 1 at a dry laydown of 8.6 g/m² (0.8g/sq ft) and dried to form a recording element according to the present invention.

### Example 5

Polymer Particle Dispersion P-3 was used to make an 18% aqueous solution. This was then coated over the ink-carrier-liquid receptive layer of Example 1 at a dry laydown of 8.6 g/m² (0.8g/sq ft) and dried to forma a recording element according to the present invention.

### Example 6

Polymer Particle Dispersion P-6 was used to make an 18% aqueous solution. This was then coated over the ink-carrier-liquid receptive layer of Example 1 at a dry laydown of 8.6 g/m² (0.8g/sq ft) and dried to form a recording element according to the present invention.

### Example 7

Polymer Particle Dispersion P-7 was used to make an 18% aqueous solution. This was then coated over the ink-carrier-liquid receptive layer of Example 1 at a dry laydown of 8.6 g/m² (0.8g/sq ft) and dried to form a recording element according to the present invention.

### Example 8

A dispersion of (1) polymeric particles P-4, (2) the colloidal cationic mordant divinylbenzene-co-N-vinylbenzyl-N,N,N-trimethylammonium chloride, and (3) poly(vinyl alcohol) (GH17 GOHSENOL from Nippon Gohsei) were diluted at the dry weight ratio of 75/15/10 to make an 18% aqueous dispersion, dry weight of particles in the dispersion. This was then coated over the ink-carrier-liquid receptive layer of Example 1 at a dry laydown of 6.2 g/m² (0.6 g/sqft) and dried to form a recording element comprising a dye-trapping layer coated over an ink-carrier-liquid-receptive layer on a support.

### Example 9

Polymer Particle Dispersion P-5 was diluted to make an 18% aqueous solution. This was then coated over the dye-trapping layer of Example 8 at a dry laydown of 8.6 g/m² (0.8g/sq ft) and dried to form a comparative recording element comprising an ink-receptive layer coated over a dye trapping layer coated over an ink-carrier-liquid receptive layer on a support.

### Example 10

Polymer Particle Dispersion P-1 was used to make an 18% aqueous solution. This was then coated over Example 8 at a dry laydown of 6.2 g/m² (0.6 g/sq ft) and dried to form a recording-element according to the present invention.

### Example 11

Polymer Particle Dispersion P-2 was used to make an 18% aqueous solution. This was then coated over Example 8 at a dry laydown of 6.2 g/m² (0.6 g/sq ft) and dried to form a recording element according to the present invention.

### Example 12

Polymer Particle Dispersion P-3 was used to make an 18% aqueous solution. This was then coated over Example 8 at a dry laydown of 6.2 g/m² (0.6 g/sq ft) and dried to form a recording element according to the present invention.

### Example 13

Polymer Particle Dispersion P-6 was used to make an 18% aqueous solution. This was then coated over Example 8 at a dry laydown of 6.2 g/m² (0.6 g/sq ft) and dried to form a recording element according to the present invention.

### Example 14

Polymer Particle Dispersion P-7 was used to make an 18% aqueous solution. This was then coated over Example 8 at a dry laydown of 6.2 g/m² (0.6 g/sq ft) and dried to form a recording element according to the present invention.

### Example 15

Polymer Particle Dispersion P-9 was used to make an 18% aqueous solution. This was then coated over the ink-carrier-liquid receptive layer of Example 1 at a dry laydown of 8.6 g/m² (0.8g/sq ft) and dried to form a recording element according to the present invention.

### Example 16

Polymer Particle Dispersion P-10 was used to make an 18% aqueous solution. This was then coated over the ink-carrier-liquid receptive layer of Example 1 at a dry laydown of 8.6 g/m² (0.8g/sq ft) and dried to form a recording element according to the present invention.

### Example 17

Polymer Particle Dispersion P-11 was used to make an 18% aqueous solution. This was then coated over the ink-carrier-liquid receptive layer of Example 1 at a dry laydown of 8.6 g/m² (0.8g/sq ft) and dried to form a recording element according to the present invention.

Printing

Examples 2 through 7, Examples 9 through 14, and Examples 15 through 17 were printed with a CANON i960 inkjet printer with Eastman Kodak pigment inks, with a test target comprised of 1 cm² color patches, a set of each of the primary and secondary colors. Each patch was printed at 100% density.

Examples 9 through 14 were also printed with a CANON i550 printer with the installed CANON dye-based inks, with a test target comprised of 1 cm² color patches, a set of each of the primary and secondary colors. Each patch was printed at 100% density.

Fusing and Testing

The printed elements were allowed to dry for 1 hour and then were fused in a heated nip at 125° C. and 4.2 kg/cm² against a sol-gel coated polyimide belt at 76 cm/min. A drop of water, coffee, and fruit punch (HAWAIIAN PUNCH, which contains Red Dye #40 and Blue Dye #1) were placed on the color patches and a white non-printed area and allowed to set for 10 minutes and then blotted off. Each area where a drop was placed was visually inspected for any stain, watermarks, and deformations to the surfaces. If any stain, watermark, or deformation was detected it was assigned a failing grade. If no stain, watermark or deformation was seen it was assigned a passing grade. Table 2 summarizes the results:

TABLE 2

| | | Intermediate | | Stain |
|---|---|---|---|---|
| Recording Element | Top Layer | Layer | Ink | Test |
| Comp. Example 2 | P-8 | — | Pigment | Fail |
| Example 3 | P-1 | — | Pigment | Pass |
| Example 4 | P-2 | — | Pigment | Pass |
| Example 5 | P-3 | — | Pigment | Pass |
| Example 6 | P-6 | — | Pigment | Pass |
| Example 7 | P-7 | — | Pigment | Pass |
| Comp. Example 9 | P-5 (non- | P-4, mordant, PVA | Pigment | Fail |
| | react) | | | |
| Example 10 | P-1 | P-4, mordant, PVA | Pigment | Pass |
| Example 11 | P-2 | P-4, mordant, PVA | Pigment | Pass |
| Example 12 | P-3 | P-4, mordant, PVA | Pigment | Pass |
| Example 13 | P-6 | P-4, mordant, PVA | Pigment | Pass |
| Example 14 | P-7 | P-4, mordant, PVA | Pigment | Pass |
| Comp. Example 9 | P-5 (non- | P-4, mordant, PVA | Dye | Fail |
| | react) | | | |
| Example 10 | P-1 | P-4, mordant, PVA | Dye | Pass |
| Example 11 | P-2 | P-4, mordant, PVA | Dye | Pass |
| Example 12 | P-3 | P-4, mordant, PVA | Dye | Pass |
| Example 13 | P-6 | P-4, mordant, PVA | Dye | Pass |
| Example 14 | P-7 | P-4, mordant, PVA | Dye | Pass |
| Example 15 | P-9 | — | Pigment | Pass |
| Example 16 | P-10 | — | Pigment | Pass |
| Example 17 | P-11 | — | Pigment | Pass |

The data clearly shows that in all cases where the internally crosslinkable particles are used to thermally set the coatings, excellent stain resistance was obtained. When no such internally crosslinkable particles were used, poor stain resistance was obtained.

The invention has been described with reference to a preferred embodiment. However, it will be appreciated that a person of ordinary skill in the art can effect variations and modifications without departing from the scope of the invention.

1. A method of making an aqueous dispersion of multifunctional polymer particles that comprise a thermoplastic polymer having at least two different reactive functional groups on each polymer molecule that are capable of reacting with each other to crosslink the thermoplastic polymer when subjected to elevated temperature, the method comprising reacting at least two different monomers having, respectively, different reactive-functional groups in an aqueous solvent in the presence of a redox polymerization initiator system comprising first and second redox initiator components, wherein the temperature of reaction is maintained under about 50° C. such that the reactive functional groups remain substantially unreacted, thereby forming a polymerization product of the monomers in the form of an aqueous dispersion of the multifunctional polymer particles having an average particle size less than 10 μm.

2. The method of claim 1 wherein the method comprises:
(a) forming an aqueous monomer emulsion comprising at least two different monomers having, respectively, different reactive-functional groups, a first redox initiator component, and optionally a surfactant,
(b) forming an aqueous composition comprising a complementary second redox initiator component, and
(c) adding the aqueous monomer emulsion to the aqueous composition over an extended period of time to form the polymerization product.

3. The method of claim 1 wherein the redox polymerization initiator system comprises an oxidizing agent and a reducing agent.

4. The method of claim 1 wherein (a) the total amount of monomer to be reacted, including the at least two different monomers with, respectively, different reactive-functional groups, (b) the total amount of the redox polymerization initiator system, and (c) optionally a surfactant is first admixed in a single reactor to form an aqueous monomer emulsion, wherein the temperature of reaction is maintained under about 50° C., and then reacted.

5. The method of claim 1 wherein the at least two different monomers comprise an acid monomer selected from the group consisting of an ethylenically unsaturated acid, mono-protic or diprotic, anhydride or monoester of a dibasic acid.

6. The method of claim 1 wherein the multifunctional polymer particles range in size from about 0.1 to about 10 μm.

7. The method of claim 6 wherein the multifunctional polymer particles have a monodispersity less than 1.3.

8. The method of claim 1 wherein the number average molecular weight of the thermoplastic polymer is from 5,000 to 1,000,000 and the glass transition temperature is above about 20° C. and less than about 100C.

9. The method of claim 1 wherein the thermoplastic polymer comprising the multifunctional polymer particles is a chain growth polymer selected from the group consisting of a styrenic polymer, vinyl polymer, ethylene-vinyl chloride copolymer, acrylic polymer, poly(vinyl acetate), poly(vinylidene chloride), vinyl acetate-vinyl chloride copolymer, and copolymers thereof.

10. The method of claim 1 wherein the thermoplastic polymer comprising the multifunctional polymer particles is a polyacrylate polymer or copolymer comprising one or more monomeric units derived from an alkyl acrylate or an alkyl methacrylate monomer, wherein the alkyl group preferably has 1 to 10 carbon atoms.

11. The method of claim 1 wherein the thermoplastic polymer comprising the multifunctional polymer particles comprises a first monomeric unit having a reactive functionality selected from the group consisting of oxazoline, epoxy, acid, anhydride, acetoacetoxy, primary or secondary amine, hydroxyl, phenol, thiol and isocyanate functionalities and, in addition, a second monomeric unit having a complementary reactive functionality, the complementary reactive functionalities being selected from the same group, such that the reactive functionalities are capable of crosslinking.

12. The method of claim 11 wherein the thermoplastic polymer comprising the multifunctional polymer particle comprises 0.5 to 50 percent of monomeric units having first reactive functionalities selected from the group consisting of epoxy and/or oxazoline groups and second reactive functionalities selected from the group consisting of acid-functional, hydroxy-functional, amine-functional, and anhydride functional groups.

13. The method of claim 1 wherein at least two different monomers, respectively, comprise a hydroxy group and an epoxy group.

14. The method of claim 1 wherein at least two different monomers, respectively, comprise a hydroxy group and carboxylic acid group.

15. The method of claim 1 wherein at least two different monomers, respectively, comprise an oxazoline group and carboxylic acid group.

16. The method of claim 1 wherein at least two different monomers, respectively, comprise an epoxy group and a carboxylic acid group.

17. The method of claim 1 wherein at least two different monomers, respectively, comprise an acetoacetoxy and amine functionality.

18. The method of claim 1 wherein at least two different monomers, respectively, comprise an epoxy and amine functionality.

19. The method of claim 1 wherein at least two different monomers, respectively, comprise an anhydride and amine functionality.

20. A composition comprising multifunctional polymer particles that comprise a thermoplastic polymer having at least two different reactive functional groups that are capable of reacting with each other in the same polymer molecule or with another molecule in the same or another multifunctional polymer particle to crosslink the thermoplastic polymer when subjected to elevated temperatures and optional pressure.

21. The composition of claim 20 wherein the composition is an aqueous dispersion of the multifunctional polymer in an aqueous solvent, optionally in further combination with a polymeric binder in the aqueous solvent.

22. The composition of claim 20, useful for a coating composition, further comprising a white or non-white colorant.

23. The composition of claim 21 wherein the polymeric binder is water-soluble or water-dispersible.

24. The composition of claim 21 wherein the weight ratio of the multifunctional polymer particles in the composition is at least 10 percent by weight of solids in the aqueous dispersion.

25. The composition of claim 20 wherein the composition further comprises UV absorbers, surfactants, emulsifiers, coating aids, lubricants, matte particles, rheology modifiers, crosslinking agents, antifoggants, inorganic fillers, pigments, magnetic particles, and/or biocides.

26. The composition of claim 20 wherein the multifunctional polymer particles have a monodispersity less than 1.3.

27. The composition of claim 20 wherein the number average molecular weight of the thermoplastic polymer is from 5,000 to 1,000,000 and the glass transition temperature is above about 20° C. and less than about 100° C.

28. The composition of claim 20 wherein the thermoplastic polymer comprising the multifunctional polymer particles is a polyacrylate polymer or copolymer comprising one or more monomeric units derived from an alkyl acrylate or an alkyl methacrylate monomer, wherein the alkyl group has 1 to 10 carbon atoms.

29. The composition of claim 20 wherein the thermoplastic polymer comprising the multifunctional polymer particles comprises a first monomeric unit having a reactive functionality selected from the group consisting of oxazoline, epoxy, acid, anhydride, acetoacetoxy, primary or secondary amine, hydroxyl, phenol, thiol and isocyanate functionalities and, in addition, a second monomeric unit having a complementary reactive functionality, the complementary reactive functionalities being selected from the same group, such that the reactive functionalities are capable of crosslinking.

30. The composition of claim 29 wherein the thermoplastic polymer comprising the multifunctional polymer particle comprises 0.5 to 50 percent of monomeric units having complementary reactive functionalities selected from the group consisting of epoxy and/or oxazoline groups in combination with an acid-functional, hydroxy-functional, amine-functional, and/or acid-anhydride functional group.

31. The composition of claim 20 wherein the at least two different reactive functional groups comprise, respectively, a hydroxy group and an epoxy group.

32. The composition of claim 20 wherein the at least two different reactive functional groups comprise, respectively, a hydroxy group and carboxylic acid group.

33. The composition of claim 20 wherein the at least two different reactive functional groups comprise, respectively, an oxazoline group and carboxylic acid group.

34. The composition of claim 20 wherein the at least two different reactive functional groups comprise, respectively, an epoxy group and a carboxylic acid group.

35. The composition of claim 20 wherein the at least two different reactive functional groups comprise, respectively, an acetoacetoxy and amine functionality.

36. The composition of claim 31 wherein the at least two different reactive functional groups comprise, respectively, an epoxy and amine functionality.

37. The composition of claim 20 wherein the at least two different reactive functional groups comprise, respectively, an anhydride and amine functionality.

38. The composition of claim 21 wherein the aqueous dispersion comprises no binder.

39. The composition of claim 21 wherein the multifunctional polymer particles range in size from about 0.1 to about 10 μm.

40. A coating on a substrate comprising multifunctional polymer particles that comprise a thermoplastic polymer having at least two different reactive functional groups that are capable of reacting with each other in the same polymer molecule or with another molecule in the same or another multifunctional polymer particle to crosslink the thermoplastic polymer when subjected to elevated temperature and optionally pressure.
